(19) United States
(12) Patent Application Publication
(10) Pub. No.: US 2024/0334919 A1
(43) Pub. Date: Oct. 10, 2024

(54) MULTIFUNCTIONAL STRIKE INDICATOR AND SLIP BOBBER

(71) Applicant: Patrick Lee Douglas, Belgrade, MT (US)

(72) Inventor: Patrick Lee Douglas, Belgrade, MT (US)

(21) Appl. No.: 18/631,642

(22) Filed: Apr. 10, 2024

Related U.S. Application Data
(60) Provisional application No. 63/577,220, filed on Apr. 10, 2023.

(51) Int. Cl. A01K 93/00

(52) U.S. Cl. CPC A01K 93/00

(57) ABSTRACT

The present disclosure relates to a multifunctional strike indicator and slip bobber. The strike indicator comprises two hemispheres that may form a substantially spherical outer dimension around fishing line. The two hemispheres may fit frictionally together to prevent movement or slipping of the fishing line between the two hemispheres once assembled. The hemispheres may be disassembled to replace the fishing line, and reuse the strike indicator. The top insert and bottom insert compress around a foam sheet to form the spherical outer form figures of the two hemispheres. The multifunctional strike indicator may be used in a fly fishing, or traditional rod-and-reel fishing arrangement.

### CROSS-REFERENCE TO RELATED APPLICATIONS

This application is being filed on Apr. 10, 2024, as a US utility application that claims priority to and the benefit of U.S. Provisional Application No. 63/577,220, filed Apr. 10, 2023, which application is hereby incorporated by reference in its entirety.

### TECHNICAL FIELD

The present application is related to tools, equipment and methods for fishing. More specifically, the present application is directed to strike indicators or bobbers with substantially spherical outer form factors.

### BACKGROUND

The sport of fishing uses several accessories to enable a fisherman's success. These accessories may include: bobbers, strike indicators, weights, or floats. While simple fishing mechanisms include a pole, fishing line, and a hook, the named accessories specifically add to the overall success in catching a fish. Bobbers are the traditional fishing equivalent to the strike indicators used by fly-fishers. Strike indicators are used to alert a fisherman when a fish has taken the fly or bait. Strike indicators also act as a bobber in that they float on the surface prior to a fish strike, and can prevent the fly, tippet, or leader from sinking.

Strike indicators ordinarily should be very light, buoyant, and easy to use or reuse. Further, ease of casting, sensitivity to strikes, and reducing drag across the water are also important. If a strike indicator is too heavy or disruptive, it can stir the water and scare away any fish. Fishing for many species of fish requires a stealth approach, in order to keep the fish in the area when casting. However, current strike indicators miss the mark on at least one of the above-mentioned characteristics.

One of the most widely-used types of bobbers found on the market today is described in U.S. Pat. No. 8,950,107 to Rosenbloom. The Rosenbloom patent describes a floating, spherical portion, and a protrusion extending therefrom that can be coupled to a line with a split screw and a nut. The line passes through the split screw and the nut is tightened to fasten it to the bobber. This design suffers from a significant defect, in that it is asymmetrical and non-cylindrical so that it will create less even flow in the water surrounding it when cast.

An improvement to this traditional design is found in Applicant's co-pending application. US 2022/0279769, entitled “Indicator with internal attachment mechanism.” That application describes a system for holding a line that results in a spherical outer form factor and avoids the drag and disruption to the water produced by previous designs.

Furthermore, the split screw and nut described in previous solutions can create a hassle for anglers. A market exists for spare locking nuts that can be used to replace the plastic parts that are easily lost, resulting in an unusable bobber and accumulation of plastic waste in streams. User comments and reviews for the products complain about using such designs in cold weather, wind, or just routine use. Others complain of lines getting snagged or caught in the screw base of the indicator during roll casts. Still others complain that the small screws are hard to use with gloves or big fingers. The co-pending application US 2022/0279769 discloses solutions to this issue as well.

Some other examples of conventional strike indicator structures include those shown in U.S. Pat. No. 418,995 (a hollow, metal sinker), U.S. Pat. No. 6,125,574 (a fastener with a tapered, mechanical-fit mating structure between halves), and U.S. Pat. No. 4,893,433 (a spherical slip bobber). None of these, however, provides a substantially spherical bobber that engages the line and avoids loose parts that can be lost.

Some strike indicators may require being tied to the leader, while others come with fastening systems, or even directly “stick” to the leader through adhesion or mechanical interference. The ease in attachment is crucial to overall satisfaction, and tedious attachment mechanisms, or situations where the threaded portion is wider than the receiving portion, can cause pain to the fingers and thumb caused by the hardware required for attachment. Stick-on indicators may fall off more easily on windy days, or glue themselves to the leader on hot days.

Strike indicators may even require tools or added items to attach the indicator to the leader, thus creating a problem if parts or pieces go missing or are lost, as they can easily fall to the ground or in the stream around the angler. Further, if the kit or tool does not include additional replacement parts, a fisherman may be out of luck when they realize the part is missing. Windy situations can also impact the effectiveness of a strike indicator. The strike indicator must therefore be equally light, buoyant, and securely attached to the leader to prevent tangling or moving.

Attaching the indicator to the line or leader may require an external protrusion from the indicator itself, to thread the line or leader through. The shape of the indicator itself may be round, spherical, cylindrical, disk-like, or oblong. The general shape of the strike indicator can also contribute to the overall effectiveness, buoyancy, and its ability to be casted efficiently. Several materials have been used for strike indicators, including foam, rubber, cork, yarn, or other materials that are known to be buoyant. Generally, strike indicators are either too heavy, too prone to kinking, knotting, or tangling the leader, or have additional appendages that create extra drag across the water.

Therefore, there exists a need for a strike indicator that is buoyant, lightweight, and does not have external protrusions or appendages.

Strike indicators can come in either of two types. The first slides along the line freely, while the second, referred to as a no-slip strike indicator, sticks firmly on the line and does not move along it. The primary benefit of a no-slip strike indicator is its ability to indicate even the most delicate strikes. By suspending the fly line and leader on the water's surface, it provides a visual cue when a fish takes the fly, allowing the angler to react quickly and set the hook. No-slip strike indicators are designed to be highly sensitive, moving or twitching at the slightest movement of the fly underwater. In addition to strike detection, a no-slip strike indicator allows for precise depth control. By adjusting the position of the indicator on the leader, anglers can present their fly at different levels in the water column, effectively targeting fish at various depths. Maintaining a drag-free drift is crucial in fly fishing, and a no-slip strike indicator helps achieve this. It acts as a visual reference point for monitoring the movement of the fly in the current, ensuring that the fly drifts naturally and convincingly, increasing the chances of enticing fish to strike.

In contrast to a no-slip strike indicator, a strike indicator that does slip along the line offers a set of unique benefits in fly fishing. This type of indicator, often referred to as a slip bobber, provides anglers with distinct advantages in certain fishing scenarios. One of the primary benefits of a slip bobber is its ability to slide up and down the line between the hook or weight and a stop set at any desired depth. The slip indicator also allows the indicator to slide down the line while the line is being reeled in so that there is not an excessive amount of line hanging off of the tip of the rod when fishing in deeper water. The slip feature of the indicator also enables natural drift presentation. The indicator moves with the current, mimicking the movement of the fly more realistically, which can be particularly effective when imitating insects or prey that exhibit drifting behavior. Additionally, a slip bobber indicator allows for delicate presentations. Since it moves freely, it offers less resistance to the fish when it takes the fly. This can be advantageous when fishing in situations where fish are more easily spooked or when targeting species that are known for subtle takes.

The slip functionality of the indicator can also enhance line management. As the line moves through the indicator, it reduces the likelihood of tangles or line interference, ensuring a smooth and uninterrupted cast and drift. Furthermore, slip bobbers can facilitate changing the depth at which the fly is presented without re-rigging. This adaptability is useful when fishing in waters with varying depths or when adjusting to fish behavior. Slip bobbers provide versatility in fly fishing techniques. They can be employed in a range of fishing methods, including nymphing, dry-dropper rigs, and even streamer fishing, allowing anglers to adapt to different fishing conditions and strategies.

### SUMMARY

The present disclosure is directed to a strike indicator that may include two hemispheres having a substantially spherical outer dimension, with coupling components to facilitate a locking mechanism. The hemispheres may be composed of foam that is substantially compressible. The compressibility of the foam, as well as the rigid inner components, aid in the capture of the fishing line between the two spherical hemispheres. The rigid hardware within each hemisphere coming together prevents slip and holds the line in place. The slot on the bottom hemisphere also provides a mechanism of secure attachment and engagement of the fishing line. The foam may eliminate gaps between the top hemisphere and the bottom hemisphere when closed and a variety of line diameters. The foam may also create friction between the top hemisphere and the bottom hemisphere to keep the parts from coming unscrewed while in use. If a gap is present, it can catch and tangle fishing line during casting, but also prevents the need for different strike indicators based on the diameter of the fishing line. A screw and nut within each respective hemisphere captures the line to form a friction fit and prevent line movement relative to the strike indicator.

In another aspect, the strike indicator has a four-way screw housed in a rigid inner component, and a nut component configured to rotationally engage with the four-way screw. The four-way screw is affixed to the bottom hemisphere at a central region thereof, the nut component is affixed to the top hemisphere at a central region thereof, and the top and the bottom hemisphere are configured to connect with the substantially flat inner surface of the top hemisphere flush to the substantially flat inner surface of the bottom hemisphere when the four-way screw is engaged with the nut component.

In another aspect, the bottom hemisphere has a concave slot running through it along an axis, and the slot is facilitated to hold fishing line running in a perpendicular direction. The strike indicator may have a no slip, and a slip position. In the no slip position, the top hemisphere and the bottom hemisphere are rotated in a closed position, with the four-way screw and the nut component holding the fishing line in place, and the substantially flat surfaces of the top hemisphere and the bottom hemisphere compressing to prevent the strike indicator from being disengaged.

In another aspect, in the slip position the top hemisphere and the bottom hemisphere are rotated in a closed position with the fishing line passing freely through the slot in the four-way screw, and the substantially flat surfaces of the hemispheres are compressed to prevent the strike indicator from being disengaged. The top hemisphere and bottom hemisphere can disengage by unscrewing the top hemisphere from the bottom hemisphere, disengaging the nut component from the four-way screw.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIGS. 1A and 1B are side views of an assembled strike indicator, according to two embodiments.

FIGS. 2A and 2B are exploded views of a top hemisphere of a strike indicator, and a bottom hemisphere of a strike indicator, in an open or non-threaded arrangement, according to the embodiments shown in FIGS. 1A and 1B.

FIG. 3 is a side exploded view of a strike indicator assembly, according to one embodiment.

FIG. 4 is perspective view of a top hemisphere of a strike indicator, according to one embodiment.

FIG. 5 is a perspective view of a bottom hemisphere of a strike indicator with a screw assembly set back into a gap, according to one embodiment.

FIG. 6 is perspective view of a female nut coupling component and a corresponding male screw coupling component, according to one embodiment.

FIG. 7 is a perspective view of a screw assembly, with a female nut coupling component and a male screw coupling component.

FIG. 8A is a perspective view of a disassembled strike indicator with fishing line, according to one embodiment.

FIG. 8B is a perspective view of an assembled strike indicator with fishing line, according to one embodiment.

FIG. 8C is a perspective view of an assembled strike indicator with hollow hemispheres, according to one embodiment.

FIG. 9 is a perspective view of a second embodiment of an assembled strike indicator.

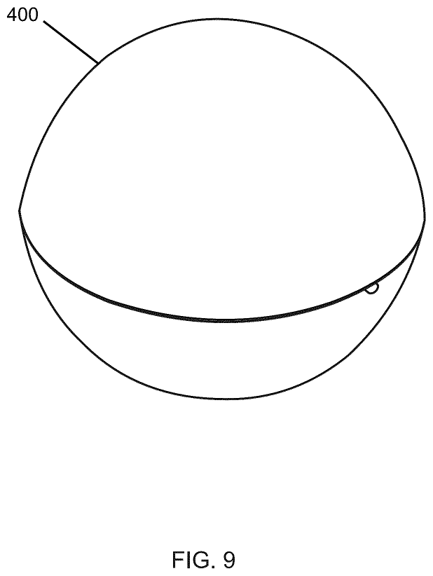

FIG. 10 is a perspective view of a top hemisphere of a strike indicator, and a bottom hemisphere of a strike indicator, in an open or non-threaded arrangement, according to the embodiments shown in FIG. 19.

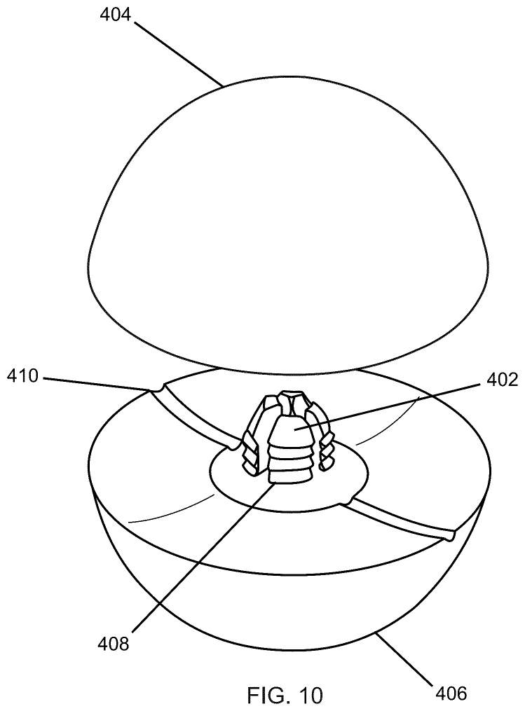

FIG. 11 is a perspective view of a bottom hemisphere of a strike indicator, according to a second embodiment.

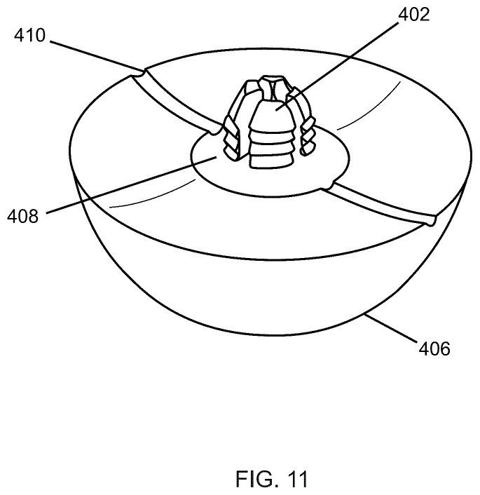

FIG. 12 is a perspective view of a top hemisphere of a strike indicator, according to a second embodiment.

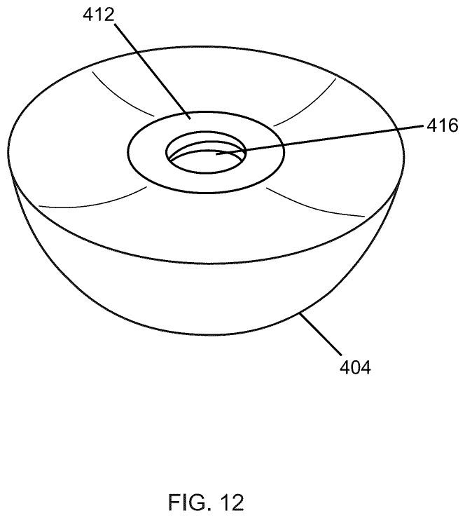

FIG. 13 is a perspective view of a top hemisphere of a strike indicator, and a bottom hemisphere of a strike indicator, in an open or non-threaded arrangement, with a fishing line running through it in a first arrangement, according to the embodiments shown in FIG. 9.

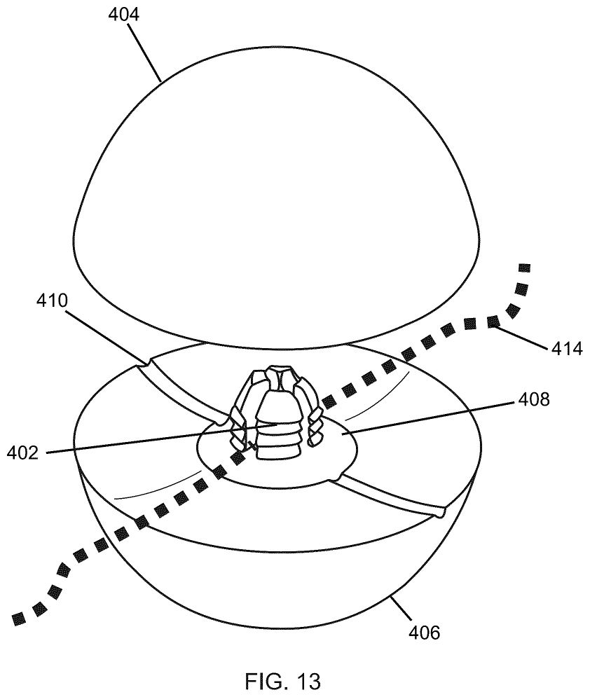

FIG. 14 is a perspective view of a top hemisphere of a strike indicator, and a bottom hemisphere of a strike indicator, in an open or non-threaded arrangement, with a fishing line running through it in a second arrangement, according to the embodiments shown in FIG. 9.

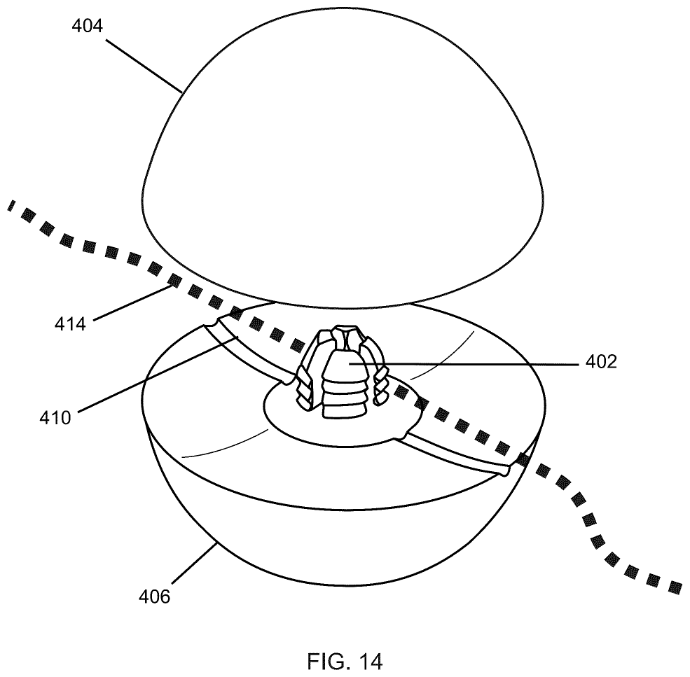

FIG. 15 is a perspective view of a top hemisphere of a strike indicator, and a bottom hemisphere of a strike indicator, in an open or non-threaded arrangement, with a fishing line running through it in a second arrangement, according to the embodiments shown in FIG. 9.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

The present disclosure relates to a strike indicator assembly comprising two substantially spherical hemispheres with coupling components. The assembly comprises a top hemisphere and a bottom hemisphere. Either of both of the bottom hemisphere or the top hemisphere may have an internal gap to facilitate the engagement of a screw assembly to connect the top hemisphere to the bottom hemisphere. In other embodiments, the internal gap can be partially in the top hemisphere and partially in the bottom hemisphere. The screw assembly may comprise a female nut coupling component that may be reversibly engaged with the male screw coupling component. In embodiments, nothing (aside from a captured fishing line) extends beyond a substantially cylindrical outer form factor that would cause the indicator to be imbalanced or cumbersome.

The present disclosure also relates to a multifunctional static strike indicator or slip bobber. The multifunctional strike indicator may be used as a static strike indicator in a fly-fishing capacity, or it may be used as a slip bobber in a rod-and-reel fishing capacity. Strike indicators and bobbers function in similar capacities. Throughout the disclosure, the term strike indicator may be used to refer to both strike indicators and slip bobbers as it relates to the claimed invention.

The strike indicator may have a four-way split screw and line slot in place of the male screw coupling component and the female nut coupling component. The four-way split screw provides multiple options for rigging the strike indicator, depending on how the line is routed through the four-way split screw.

Throughout this disclosure, the term “substantially” is used to make clear that the hemispherical or spherical form factor of the devices described herein need not be exact. As described in more detail below, in one embodiment these devices can be formed by compressing polymer foam, or in another by cutting cork to shape. Each of these processes has a tolerance and expected deviation. As shown in some of the drawings, in the polymer compression embodiment there may be slight lips at the base of the hemispherical portion, however it should be understood that this does not detract from the overall, substantially hemispherical nature of those components. Likewise, a slight misalignment between male and female portions of the nut and screw that holds these hemispheres is to be expected, and normal machining tolerances after quality control would not result in a device that is understood to have anything but a substantially spherical form factor. Depending on the processes and materials used, these tolerances can vary from device to device, and “substantially” is used as a stand-in to acknowledge the variability of these physical processes and materials. As a general matter, as described above, devices should be understood to be substantially spherical if they create negligible non-uniform drag that would be undesirable to a fly-fisher, such as those caused by conventional devices that include asymmetric or protruding features.

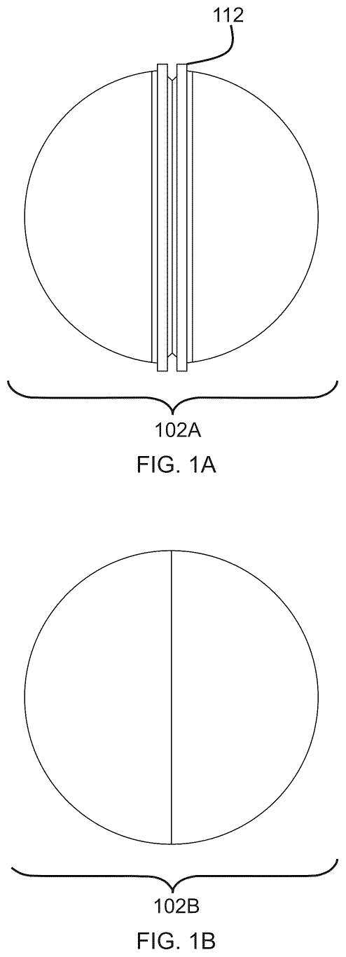

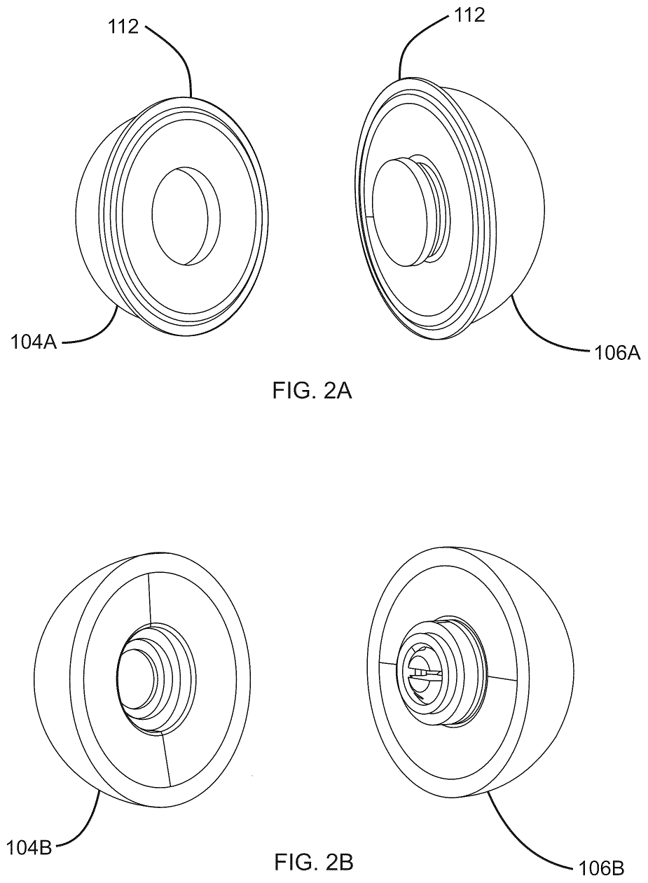

Referring now to FIGS. 1A and 1B, a representative embodiment of an assembled strike indicator (102A and 102B, respectively). FIGS. 1A and 1B illustrate example embodiments of a side view of the assembled strike indicator. These two drawings show two similar embodiments; the version in FIG. 1A includes a small flange 112 (see FIG. 2A) formed during a manufacturing process, while FIG. 1B has a substantially spherical form factor that that eliminates this flange structure. Despite this minor structural difference, each of these overcomes the deficiencies of conventional devices described above.

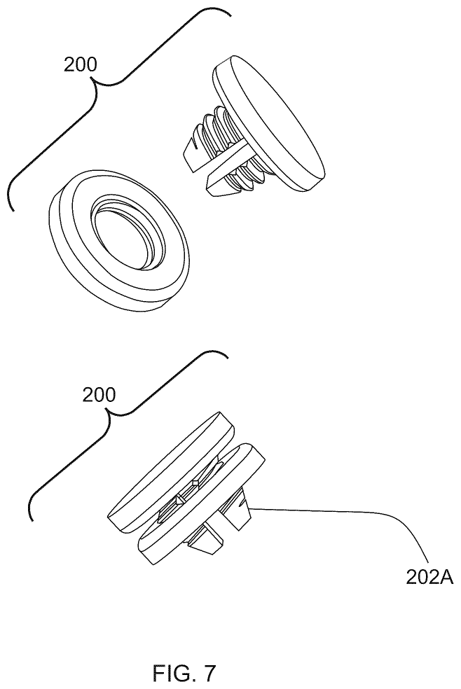

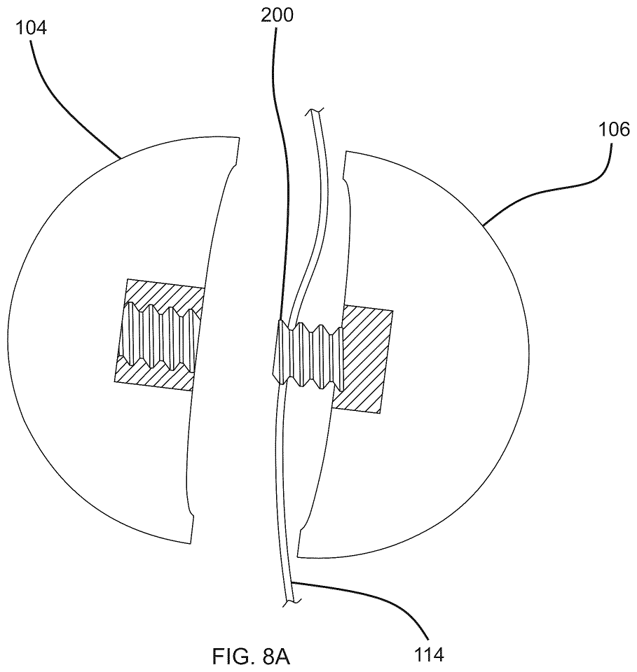

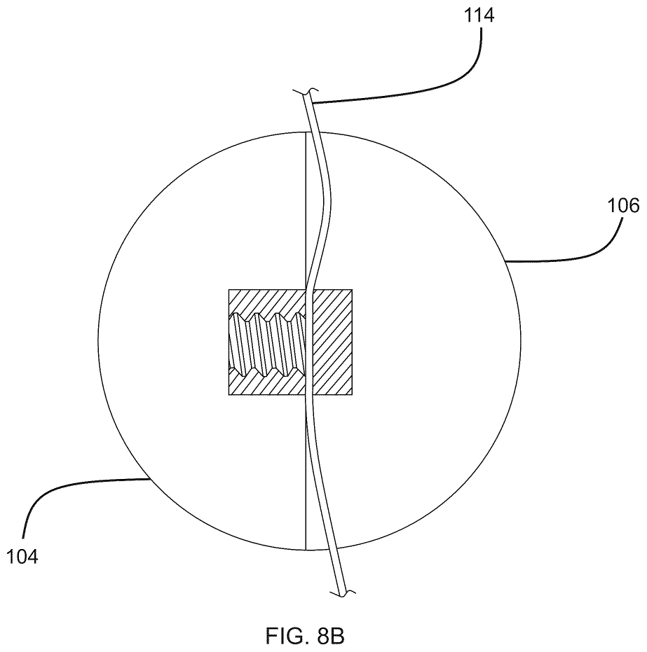

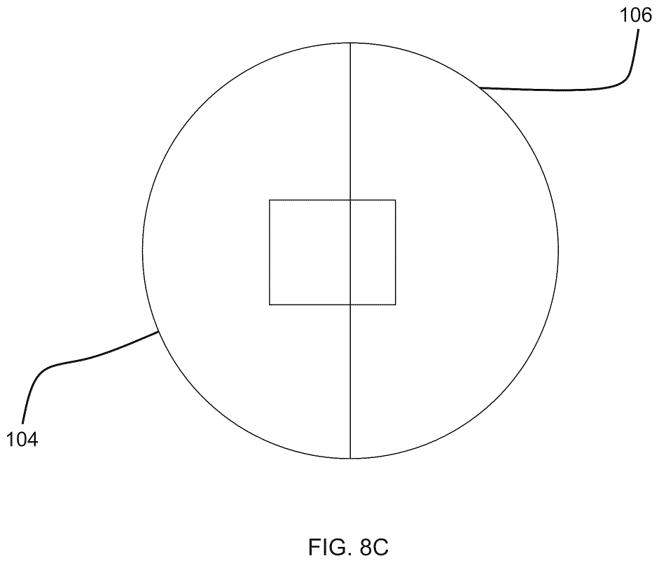

The top and bottom hemispheres (104A/104B and 106A/106B, respectively, as shown in FIGS. 2A and 2B) are interlocked using the screw assembly 200 (see FIG. 7). According to the side view in FIGS. 1A and 1B, fishing line 114 (see FIG. 8) of any diameter may run vertically, passing through where the two hemispheres abut one another. The fishing line 114 diameter may fall within the range of 0.10-0.60 mm, in embodiments. The top and bottom hemispheres (104A/104B and 106A/106B) may be held together using the screw assembly 200. The top and bottom hemispheres (104A/104B and 106A/106B, respectively) abut one another to form the spherical outer dimension of the assembled strike indicator 102A/102B, when the flat portions of the hemispheres abut one another.

Different embodiments within the scope of the invention can have different sizes. For example a “small sized” embodiment can be configured for use with line sizes of 0.10 to 0.60 mm, and the device itself when assembled as a diameter of 0.65 inches (16.5 mm). A medium-sized device can be used with larger lines, such as from about 0.21 mm to about 0.60 mm, and the device has an assembled diameter of 0.85 inches (21.6 mm). A large-sized device can be suitable for lines having a diameter of 0.40 mm to about 0.60 mm, and have an assembled diameter of 1.05 inches (26.7 mm). Larger devices may be more suitable for larger line sizes, to correspond to expected fishing conditions and avoid snapping thin lines in extreme scenarios.

In addition to the advantages described above, devices described herein can have interchangeable top and bottom hemispheres. For a variety of reasons both practical and aesthetic, an angler may wish to have two differently colored halves to the device, for example. By mixing and matching these colors or patterns, specific combinations can be formed based on angler preference, or in tournaments to indicate a sponsor or team. It is therefore contemplated that kits including one or more hemispheres (whether only top hemispheres, only bottom hemispheres, or a combination of top and bottom hemispheres) could be provided that would facilitate this type of mixing and matching. These kits could be all of one type (bottom or top hemispheres) or they could be an assortment. Likewise, the kits could include different styles or colors from one another, or they could all be the same type.

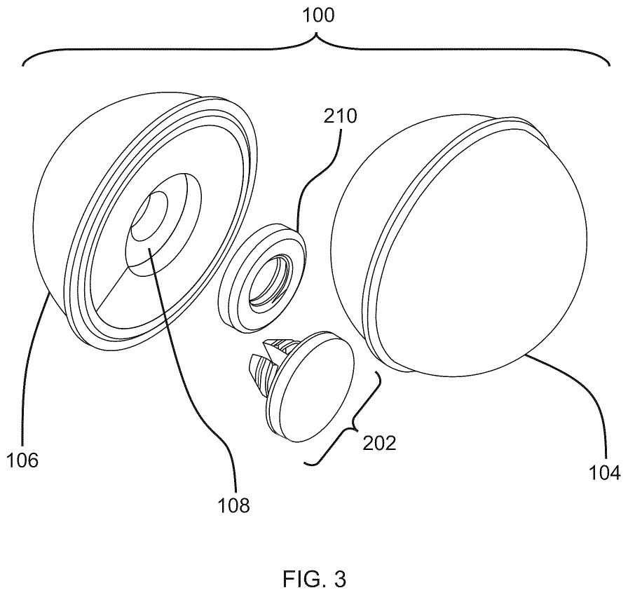

Referring now to FIGS. 2A and 2B, a perspective view of a top hemisphere of a strike indicator, and a bottom hemisphere of a strike indicator, are shown. In this view, the screw 202 is still fully engaged with the nut 210 (FIG. 3), but the remaining foam of the top hemisphere 104 (which would normally be affixed to the screw 202) is pulled back for ease of viewing. The top hemisphere 104 and the bottom hemisphere 106 may define a gap 108 (FIG. 3) therebetween to facilitate engagement of the screw assembly 200 and eliminate the catching problem of conventional solutions. The screw 202 and the nut 210 are each coupled to their respective hemispheres (104 and 106), in the finished device. That coupling can be permanent (e.g., with adhesive or molding) in embodiments, or it can be semi-permanent or removable. In order to maintain a substantially spherical form factor for the overall assembled strike indicator 102 no matter how tightly or loosely screwed together the halves are, the screw 202 and the nut 210 are affixed to their respective hemispheres (104 and 106) at a central region thereof. As described above, the placement in the center may not be exact, but should be within standard part, assembly, and machining tolerances, such as by using molds described in Applicants co-pending application which is incorporated by reference (US 2022/0279769).

Both the top hemisphere 104 and the bottom hemisphere 106 may be substantially the same size to facilitate a closer friction-fit when assembled. Each hemisphere has a flange 112 that extends around the flat perimeter of the hemisphere. Again referring the FIGS. 2A and 2B, the bottom hemisphere 106 illustrates the engagement of the screw assembly 200, and the female nut coupling component when screwed into the gap 108 of the bottom hemisphere 106. The surfaces of the top and bottom hemispheres (104 and 106) may be substantially flat to encompass a slight concavity.

Referring now to FIG. 3, a representative embodiment of a strike indicator assembly 100 is shown. The strike indicator assembly 100 of FIGS. 1 and 2 includes a top hemisphere 104, a bottom hemisphere 106, a gap 108 within the bottom hemisphere 106, and a screw assembly 200 (see FIG. 8). The top hemisphere 104 and the bottom hemisphere 106 are identical in appearance and shape, aside from the gap 108 within the bottom hemisphere 106 to facilitate the setback of the screw assembly 200. In other embodiments, the gap can be present on one or both hemispheres. The top hemisphere 104, and the bottom hemisphere 106 may be made of a foam material, or any other reasonably compressible and buoyant material.

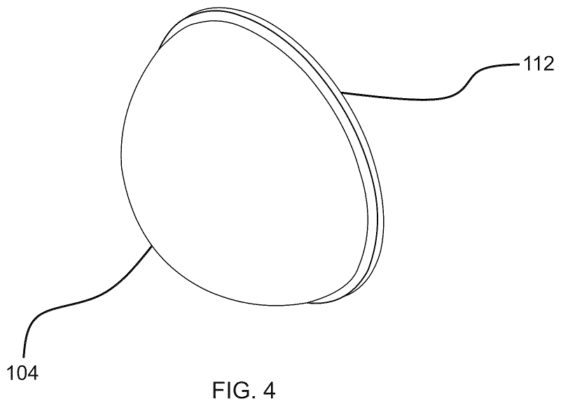

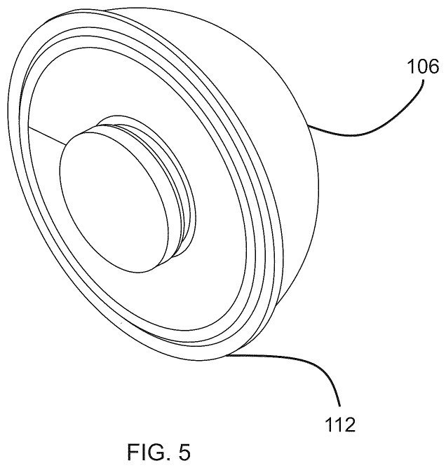

Referring now to FIGS. 4 and 5, a representative embodiment of a top and a bottom hemisphere of a strike indicator (104 and 106), respectively, though again with the screw 202 still engaged with the nut 210. The top hemisphere 104 and the bottom hemisphere 106 may have a spherical outer dimension or form factor. While there may be some deviation from a perfectly spherical outer form factor due to manufacturing tolerances and compression or movement of the material that makes up the hemispheres 104 and 106, again it should be understood that by “substantially spherical” it is meant that there are no discontinuities or protuberances that significantly affect the overall article's performance as a spherical strike indicator. The top hemisphere 104, and the bottom hemisphere 106, may be made of a compressible foam. The bottom hemisphere 106 differs slightly from the top hemisphere 104, in the sense there may be a gap 108 within the bottom hemisphere 108 (see the cross-sectional view of FIG. 8 for more detail). The gap 108 within the bottom hemisphere allows for engagement with the screw assembly 200. The top and bottom hemisphere (104 and 106) interlock to form an assembled strike indicator 102.

In another embodiment of FIGS. 4 and 5, the top hemisphere 104, and the bottom hemisphere 106, may be shaped in an ovular nature rather than spherical. The gap 108 within the bottom hemisphere 106 may be shaped to engage with a different sized screw or attachment mechanism. As shown in these figures, a flange 112 may also extend around each hemisphere (104, 106) at the edge of the faces where they intersect, though this does not detract from the overall spherical or oval form factor.

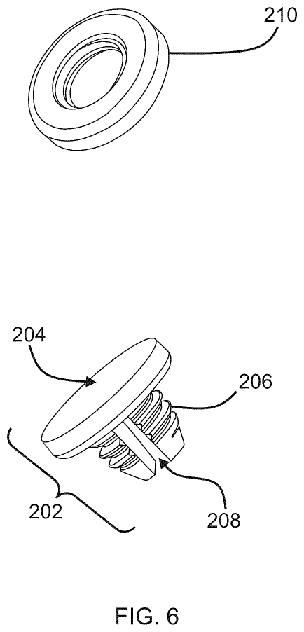

Referring now to FIGS. 6 and 7, representative embodiments of a screw assembly 200 and its components. The screw assembly 200 comprises a male screw coupling component 202, with a head 204, and a threaded portion 206. The screw 202 may have a notch 208 to allow for a fishing line 114 to pass therethrough when the screw is engaged to the coupling component (e.g., 210). The screw assembly 200 also may have a female nut coupling component 210, with a centrally located aperture that allows for the threaded portion 206 of the screw 202 to threadingly engage with the female nut coupling component 210.

As shown in FIG. 7, the nut 210 receives the screw 202, which has a lead 202A that is angled. This angled portion assists with getting the threading started, alleviating some of the complaints with conventional devices that are hard to manipulate in cold weather or with larger fingers or gloves.

Referring now to FIG. 8A, an embodiment of a disassembled strike indicator with fishing line threaded therethrough. The top hemisphere 104 and the bottom hemisphere 106 are separated to illustrate the substantially flat hemispheres. The compression fit of the top hemisphere 104 and the bottom hemisphere 106 may aid in keeping the screw assembly 200 engaged tightly, while the screw assembly 200 holds the fishing line 114 in place and prevents slip or movement by fitting tightly on the line.

Referring now to FIG. 8B, an embodiment of an assembled strike indicator with fishing line threaded through. The top and bottom hemispheres (104 and 106), may have substantially flat inner surfaces that interact when the screw assembly 200 is tightened. The compressibility of the foam locks around the screw assembly 200 to prevent movement and allow the hardware to create a friction fit. The screw assembly 200 locks around the fishing line 114 to hold it in place and prevent any slip.

Referring now to FIG. 8C, an embodiment of an assembled strike indicator. The assembled strike indicator may be hollow in some embodiments for purposes of flotation. Rather than being a solid foam hemisphere, the strike indicator may have a foam, or other sufficiently buoyant material that defines the outer perimeter of the hemisphere, which the remainder of the hemisphere is hollow. The hollow nature of the strike indicator aids in flotation and can be lighter than a strike indicator that is solid.

Referring back to FIG. 3, in assembly, the strike indicator assembly 100 may have three components: the top hemisphere 104, the bottom hemisphere 106, and the screw assembly 200. The screw assembly 200 may be comprised of the female nut coupling component 210 having a centrally located aperture, and the male screw coupling component 202, having the head 204 and the threaded portion 206. The screw assembly 200 may be assembled by engaging the female nut coupling component 210 with the threaded portion 206 of the male screw coupling component 202.

The gap 108 within the bottom hemisphere 106 accepts the nut 210, which in turn accepts the screw coupling component 202, such that screw assembly 200 holds the hemispheres 104 and 106 together. The gap 108 within the bottom hemisphere 106 may be present in the top hemisphere 106 in an alternate embodiment. The top hemisphere 104 and the bottom hemisphere 106 may be connected by engaging the flat portion of the top hemisphere 104 with the head 204 of the male screw coupling component 202, such as by adhesive. The foam of the assembled strike indicator 102 may be reasonably compressible and allows for a friction fit locking mechanism to hold the top hemisphere 104 and the bottom hemisphere 106 together.

Each hemisphere may have a slight indentation on the inner surface so that once they are screwed together (using the screw assembly 200), the flange 112 of each hemisphere will still fit tightly together. The indentation on the inner surface of each hemisphere may assist with the friction-fit primarily caused by the locking nut and screw, because the internal assembly components may be further compressed to prevent movement of the fishing line 114. Without said indentation the foam may become too dense to allow the screw and nut hardware to come together and lock the line. The male screw coupling component 202 may be relatively large to support a friction-fit of the top and bottom hemisphere. The male screw coupling component 202 may thereby force the foam of each hemisphere to compress around the head 204 of the male screw coupling component 202.

In operation, the top hemisphere 104 and the bottom hemisphere 106 allow for fishing line 114 to be attached internally, passing through the space between the top hemisphere 104 and the bottom hemisphere 106. The fishing line 114 may pass through the notch 208 to be secured in the center of the assembled strike indicator 102. The notch 208 facilitates use of any diameter of fishing line 114 up to the width thereof, preventing the need to have different sized screws and attachment mechanisms. The notch 208 also ensures that the line passes substantially through the center of the strike indicator assembly 100, preventing imbalance. The internal attachment of fishing line 114 enables easy application and repositioning of the assembled strike indicator 102.

Applicant's published application (US 20220279769A) discloses a tooling mold assembly for making the structures disclosed herein.

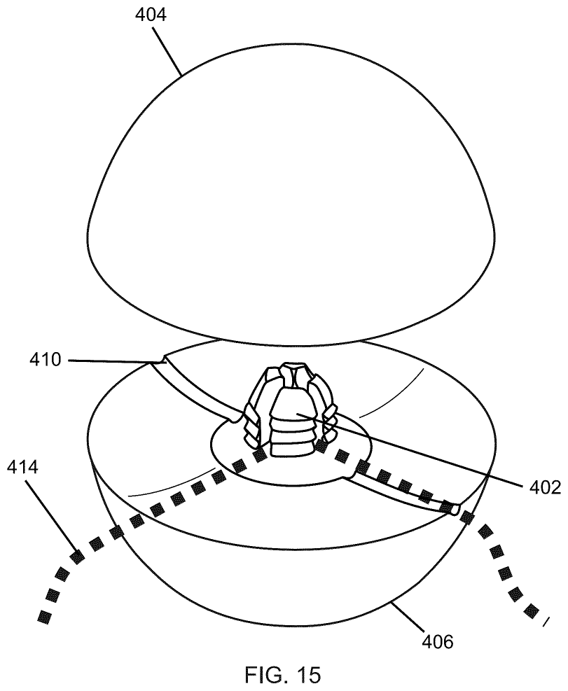

Referring now to FIG. 15, which is a second embodiment of an assembled strike indicator. The assembled strike indicator 400 may be a multifunctional static strike indicator or slip bobber. The multifunctional strike indicator may be used as a static strike indicator in a fly-fishing capacity, or it may be used as a slip bobber in a rod-and-reel fishing capacity. The assembled strike indicator 400 may have a substantially round, circular, or ovular exterior. When assembled, the strike indicator 400 may have rounded surfaces with minimal interruptions, allowing it to move smoothly through the water.

FIG. 16 shows the strike indicator 400 of FIG. 15 in a disassembled, non-threaded arrangement. The strike indicator 400 of FIG. 15 may have a top hemisphere 404, and a bottom hemisphere. The bottom hemisphere 406 features a four-way screw 402, that sits in a rigid inner component 408. The four-way screw 402 may be a threaded screw to ensure secure engagement with the top hemisphere 404. Running through the four-way screw 402 is a slot 410. The slot 410 runs along one axis of the strike indicator 400 in a perpendicular direction. The slot 410 is designed to hold fishing line. The slot 410 may be of varying depth and width based on the desired fishing line. When in an open, or non-threaded arrangement, the strike indicator 400 of FIG. 15 is in a position to have fishing line situated in the slot 410, before closing the strike indicator 400, or moving it to a threaded arrangement.

Referring now to FIG. 17, illustrating a bottom hemisphere of the strike indicator once disassembled. The bottom hemisphere 406, as shown in FIG. 16, holds the mating components of the strike indicator to allow for secure engagement with the top hemisphere. The four-way screw 402 is held in a rigid inner component 408 to prevent movement or slipping. The rigid inner component 408 may be made of a plastic or another suitable material with sufficient rigidity or hardness to provide support and secure engagement. The rigid nut 408 is a key component in creating secure, non-slip compressibility with the top hemisphere once the strike indicator is in a closed, threaded position. Running through the four-way screw in a perpendicular direction is the slot 410. The slot 410 may have a dip, concavity, or slight indenture to allow for a fishing line to be run through the slot 410. The fishing line runs at 90 degrees according to the axis of the strike indicator. As seen in FIGS. 1A-8C, the strike indicator is also designed to run a fishing line in a upper left to lower right, or upper right to lower left modes, or non-slip vs. slip modes. rather than perpendicular. The direction the fishing line is run through the strike indicator may be based on the desired style of fishing (i.e., fly fishing vs. rod and reel traditional fishing).

FIG. 18 shows the top hemisphere of the strike indicator of FIG. 15, removed from the assembly and in an open position. The top hemisphere 404 may be the same shape and size as the bottom hemisphere of FIG. 17, however, the top hemisphere 404 may have a concavity 416, with a nut 412 that provides support to the concavity 416. The concavity 416 is facilitated to house the four-way screw 402 of FIG. 17. The nut 412 may be made of a hard, or rigid material (similar to the inner component 408 of FIGS. 16 and 17), to provide support and secure engagement with the bottom hemisphere 406.

Referring now to FIGS. 19-21, which are perspective views of an assembled strike indicator in an open, or non-threaded arrangement with fishing line running through in various directions. Referring first to FIG. 19, which shows the top hemisphere 404, and the bottom hemisphere 406. The bottom hemisphere housing the four-way screw 402 within the inner component 408. Running through the four-way screw in a perpendicular direction is the slot 410, where the fishing line 414 may be situated. In an alternative embodiment, and as seen in FIG. 19, the fishing line 414 may be run through the four-way screw 402, but not along the slot 410. In this arrangement, the fishing line 414 will still be securely engaged with the strike indicator. The fishing line 414 runs along the axis of the strike indicator, and through one of the openings of the four-way screw 402.

The fishing line 414 in each of FIGS. 19-21 may be situated in a slip, or no-slip position. In a no-slip position, the top 404 and bottom 406 hemispheres are rotated in a closed position, with the four-way screw 402 and the nut 412 holding the fishing line 414 in place, with the concavity 416 of the top hemisphere compressing to prevent the threads from being unscrewed.

In a slip position, the two hemispheres (404, 406) are rotated in a closed position with the fishing line 414 passing freely through the slot in the four-way screw 402. The concave surfaces of the hemispheres are still compressed to prevent the threads from being unscrewed.

FIG. 20 shows another use of the strike indicator, with the fishing line 414 being run directly along the slot 410 on the bottom hemisphere 406. The fishing line 414 is placed through the opening on the four-way screw 402 that aligns with the slot 410. Once situated, the top hemisphere 404 maybe engaged with the bottom hemisphere 406. Engagement of the top hemisphere 404 and bottom hemisphere 406 may be done by a twisting, or turning motion of the hemispheres (404, 406). The twisting or rotation facilitates mating of the four-way screw 402 with the concavity 416 of the top hemisphere 404, as seen in FIG. 18. Once the strike indicator is in a threaded or closed position, the line is held in place by a combination of the rigid inner features (inner component 408, and nut 412), and the compressibility of the foam hemispheres (404, and 406).

Referring now to FIG. 21, which is another arrangement of the strike indicator with fishing line running in a different direction. The four-way screw 402 allows for many different arrangements, because of the four prongs of the screw. The slot 410 provides another aspect of secure engagement with the fishing line 414 because of the slight concavity or dip to house the fishing line 414. In FIG. 21, the fishing line 414 is run at a 90 degree angle, with one portion being run through a prong of the four-way screw 402, and another portion being run along the slot 410. Once the fishing line is positioned, the top hemisphere 404 may be placed on the bottom hemisphere 406, and the four-way screw 402 engaged with the ring 416 of the top hemisphere 404. After the top hemisphere 404 is engaged with the bottom hemisphere 406, the two hemispheres (404, 406) may be turned or rotated to lock the strike indicator in an assembled or threaded position.

In use, the second embodiment of the strike indicator as seen in FIGS. 15-21, has a slot 210 running through a concave surface of the bottom hemisphere 406 and a four-way split screw 402. The four-way screw 402 with the slot 410 running along the center of one axis allows for fishing line 414 to be situated in the slot of the four-way screw 402 without causing friction. The concave surface of the foam hemispheres (404, 406) with the slot 410 running down one of the axis allows the fishing line 414 to slip through the foam hemisphere. The top hemisphere 404 having a nut 412 component, and the bottom hemisphere 406 having a four-way screw 402.

The fishing line 414 may be situated in a slip, or no-slip position. In a no-slip position, the top 404 and bottom 406 hemispheres are rotated in a closed position, with the four-way screw 402 and the nut 412 holding the fishing line 414 in place, with the concavity 416 of the top hemisphere compressing to prevent the threads from being unscrewed.

In a slip position, the two hemispheres (404, 406) are rotated in a closed position with the fishing line 414 passing freely through the slot in the four-way screw 402. The concave surfaces of the hemispheres are still compressed to prevent the threads from being unscrewed.

The four-way screw 402 allows the fishing line 414 to be redirected within the strike indicator, 90 degrees from the angle of entry. When the fishing line 414 is in the 90 degree no-slip indicator position and the two hemispheres (top 404 and bottom 406) are rotated to a closed position, the four-way threaded screw 402 on the inner surface of the hemispheres holds the fishing line 414 in place. At the same time, the concave surfaces of the hemispheres compress and act to prevent the threads from unscrewing.

In another embodiment, a solid screw may be used rather than a split screw. A user can wrap the line around the solid screw, rather than passing the line through the split screw as described above. Advantages to this arrangement are less complex parts and ease of use for some users, for whom threading the screw could be difficult. Wrapping the line around the screw is a quick alternative to threading the line through a split screw and can be done even while the two hemispheres are partially threadably connected, but wrapping the line can also be harder on the line as it is being turned at a tight angle with force applied thereon, which can cause breakage.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

1. A multifunctional strike indicator assembly comprising:
a top hemisphere defining a substantially flat inner surface and a substantially hemispherical outer surface;
a bottom hemisphere defining a substantially flat inner surface with a slot running along the axis of the bottom hemisphere in a perpendicular direction, and a substantially hemispherical outer surface;
a four-way screw, housed in a rigid inner component; and
a nut component configured to rotationally engage with the four-way screw;
wherein the four-way screw is affixed to the bottom hemisphere at a central region thereof, the nut component is affixed to the top hemisphere at a central region thereof, and the top and the bottom hemisphere are configured to connect with the substantially flat inner surface of the top hemisphere flush to the substantially flat inner surface of the bottom hemisphere when the four-way screw is engaged with the nut component.

2. The strike indicator of claim 1, wherein the slot is facilitated to hold a fishing line.

3. The strike indicator of claim 1, wherein one direction of the four-way screw is aligned with the slot.

4. The strike indicator of claim 1, wherein the substantially flat inner surface of the top hemisphere includes a concavity of less than about 0.40 mm, and wherein the substantially flat inner surface of the bottom hemisphere includes a concavity of less than about 0.40 mm.

5. The strike indicator of claim 1, wherein the top hemisphere and bottom hemisphere can disengage by unscrewing the top hemisphere from the bottom hemisphere, disengaging the nut component from the four-way screw.

6. The strike indicator of claim 2, wherein the fishing line is redirected within the strike indicator, 90 degrees from an angle of entry.

7. The strike indicator of claim 1, wherein the rigid inner component is made of plastic.

8. The strike indicator of claim 1, wherein each of the top hemisphere and the bottom hemisphere define a cavity.

9. The strike indicator of claim 1, wherein the top and the bottom hemisphere are made of a compressible foam.

10. The strike indicator of claim 1, wherein the top and bottom hemisphere are made of a combination of low density materials.

11. The strike indicator of claim 1, wherein the four-way screw is set back into the bottom hemisphere and is adjustable, and made tighter or looser by compressing the four-way screw a corresponding degree into the compressible foam.

12. The strike indicator of claim 11 wherein the top and bottom hemisphere can frictionally lock around the fishing line at a range of diameters.

13. A multifunctional strike indicator assembly comprising:
a top hemisphere defining a substantially flat inner surface and a substantially hemispherical outer surface;
a bottom hemisphere defining a substantially flat inner surface with a concave slot running along the axis of the bottom hemisphere in a perpendicular direction, and a substantially hemispherical outer surface;
a four-way screw, housed in a rigid inner component; and
a nut component configured to rotationally engage with the four-way screw;
wherein the four-way screw is affixed to the bottom hemisphere at a central region thereof, the nut component is affixed to the top hemisphere at a central region thereof, and the top and the bottom hemisphere are configured to connect with the substantially flat inner surface of the top hemisphere flush to the substantially flat inner surface of the bottom hemisphere when the four-way screw is engaged with the nut component; and
wherein the concave slot is configured to hold a fishing line in a slip, or a no-slip position.

14. The strike indicator of claim 13, wherein in the no slip position, the top hemisphere and the bottom hemisphere are rotated in a closed position, with the four-way screw and the nut component holding the fishing line in place, and the substantially flat surfaces of the top hemisphere and the bottom hemisphere compressing to prevent the strike indicator from being disengaged.

15. The strike indicator of claim 13, wherein in the slip position the top hemisphere and the bottom hemisphere are rotated in a closed position with the fishing line passing freely through the slot in the four-way screw, and the substantially flat surfaces of the hemispheres are compressed to prevent the strike indicator from being disengaged.

16. The strike indicator of claim 13, wherein the top hemisphere and bottom hemisphere can disengage by unscrewing the top hemisphere from the bottom hemisphere, disengaging the nut component from the four-way screw.

17. The strike indicator of claim 13, wherein the top and the bottom hemisphere are made of a compressible foam.

18. The strike indicator of claim 17, wherein the top and bottom hemisphere are made of a low density material, other than compressible foam.

19. The strike indicator of claim 13, wherein the two hemispheres are rotated in a closed position with the line passing freely through the slot in the four-way screw. The concave surfaces of the hemispheres are still compressed to prevent the threads from being unscrewed.

20. The strike indicator of claim 13, wherein the fishing line is redirected within the strike indicator, 90 degrees from an angle of entry.
